(19) United States
(12) Patent Application Publication
(10) Pub. No.: US 2025/0060014 A1
(43) Pub. Date: Feb. 20, 2025

(54) SOLENOID ACTUATOR AND BRAKE SYSTEM INCLUDING THE SAME

(71) Applicant: HL MANDO CORPORATION, Gyeonggi-do (KR)

(72) Inventor: Jinseok KIM, Gyeonggi-do (KR)

(21) Appl. No.: 18/436,037

(22) Filed: Feb. 8, 2024

(30) Foreign Application Priority Data
Aug. 14, 2023 (KR) 10-2023-0106223

(51) Int. Cl. F16D 65/18; F16D 121/20; F16D 121/24; F16D 127/06

(52) U.S. Cl. CPC F16D 65/18; F16D 2121/20; F16D 2121/24; F16D 2127/06

(57) ABSTRACT

A solenoid actuator includes a bobbin having a through hole formed inside the bobbin and including a winding part around which a coil is wound along an outer surface of the bobbin, a lower case coupled to a lower side of the bobbin and surrounding the outer surface of the bobbin, a drive part inserted in the through hole of the bobbin to be drivable up and down, a core fixedly disposed above the drive part, and a return spring provided between the drive part and the core and configured to elastically support the drive part such the drive part can return to its original position. The bobbin may include a damper protruding from an inner peripheral surface of the through hole of the bobbin and positioned between the lower case and the drive part.

### CROSS-REFERENCE TO RELATED APPLICATION

This application claims the priority to and the benefit of Korean Patent Application No. 10-2023-0106223, filed on Aug. 14, 2023 in the Korean Intellectual Property Office, the disclosure of which is incorporated herein by reference in its entirety.

### BACKGROUND

### 1. Field

Some embodiments of the present disclosure generally relate to a solenoid actuator and a brake system including the same, and more specifically, to a solenoid actuator improving assemblability and durability by simplifying a structure and a brake system including the same.

### 2. Description of the Related Art

In vehicles, a brake system for braking is necessarily installed, and various types of brake systems have been developed for the safety of drivers and passengers.

Conventional brake systems supply hydraulic pressure required for braking to a wheel cylinder using a mechanically connected booster in response to a driver's pressing on a brake pedal. However, nowadays, for the convenience of drivers, electromechanical brake systems for braking a vehicle have been developed. For example, the electromechanical brake system receives a driver's intention to brake as an electrical signal and operates a power transmission device such as a motor based on the electrical signal.

In the related art, an electro parking brake (EPB) hydraulically implements a service brake and electrically implements only a parking brake. An electromechanical brake (EMB) electrically implementing both the service brake and the parking brake is being developed.

The electromechanical brake may use a parking gear to maintain the vehicle in a parked state when the parking brake is activated, and this parking gear maintains the vehicle in the parked state by being engaged with one of gear elements provided in an actuator of a brake system.

### SUMMARY

Therefore, it is an aspect of the present disclosure to provide a solenoid actuator which can reduce operating noise and a brake system including the same.

It is another aspect of the present disclosure is to provide a solenoid actuator capable of maintaining a constant magnetic force during operation and a brake system including the same.

It is still another aspect of the present disclosure is to provide a solenoid actuator which can improve assemblability and productivity by simplifying a product structure and shape and a brake system including the same.

It is yet another aspect of the present disclosure is to provide a solenoid actuator which can simplify product design and reduce manufacturing cost and a brake system including the same.

In accordance with one aspect of the present disclosure, a solenoid actuator includes a bobbin having a through hole formed on an inner surface thereof and including a winding part around which a coil is wound along an outer surface thereof, a lower case coupled to a lower side of the bobbin and surrounding the outer surface of the bobbin, a drive part inserted into the through hole to be drivable up and down, a core fixedly installed above the drive part, and a return spring provided between the drive part and the core and configured to elastically support the drive part to an original position of the drive part, in which the bobbin includes a damper protruding from an inner peripheral surface of the through hole and interposed between the lower case and the drive part.

The lower case may include a cylindrical body surrounding the outer surface of the bobbin, a lower surface extending inward from a lower end of the body and surrounding the lower side of the bobbin, and a cylindrical inner surface extending upward from an inner end of the lower surface and inserted into the through hole, and the damper may be provided between an upper end of the inner surface and the drive part.

The drive part may include a large diameter part inserted into the through hole and a small diameter part provided with a diameter smaller than a diameter of the large diameter part, the small diameter part may be inserted into the inner surface, and the damper may be provided to contact a stepped part formed by a difference in diameter between the large diameter part and the small diameter part.

The solenoid actuator may include a drive rod moved by the drive part.

The drive rod may pass through the drive part and be coupled thereto.

A first bush may be provided between the drive rod and the inner surface, and the first bush may be provided in a first opening formed inside the inner surface.

A second bush may be provided between the drive rod and the core.

The lower case may have the body, the lower surface, and the inner surface integrally formed.

An upper end of the drive part may be provided with a first inclined portion formed to be at least partially inclined, and a lower end of the core may be provided with a second inclined portion formed to be at least partially inclined at an angle corresponding to the first inclined portion and provided to contact the first inclined portion.

In accordance with another aspect of the present disclosure, a solenoid actuator includes a bobbin having a through hole formed on an inner surface thereof and including a winding part around which a coil is wound along an outer surface thereof, a lower case coupled to a lower side of the bobbin and surrounding the outer surface of the bobbin, a drive part inserted into the through hole to be drivable up and down, a core fixedly installed above the drive part, a return spring provided between the drive part and the core and configured to elastically support the drive part to an original position of the drive part, and a damper provided on an inner peripheral surface of the through hole and interposed between the lower case and the drive part, in which the lower case includes a cylindrical body surrounding the outer surface of the bobbin, a lower surface extending inward from a lower end of the body and surrounding the lower side of the bobbin, and a cylindrical inner surface extending upward from an inner end of the lower surface and inserted into the through hole, and the damper is provided between an upper end of the inner surface and the drive part.

In accordance with still another aspect of the present disclosure, a brake system includes a power transmission unit configured to transmit a rotational driving force of a motor to a pressing unit for pressing brake pads provided on both sides of a disc and a ratchet unit configured to prevent reverse operation of the power transmission unit, in which the ratchet unit includes a pawl provided to engage with a ratchet gear rotating with rotation of the motor and a solenoid actuator configured to rotate the pawl, the solenoid actuator includes a bobbin having a through hole formed on an inner surface thereof and including a winding part around which a coil is wound along an outer surface thereof, a lower case coupled to a lower side of the bobbin and surrounding the outer surface of the bobbin, a drive part inserted into the through hole to be drivable up and down, a core fixedly installed above the drive part, and a return spring provided between the drive part and the core and configured to elastically support the drive part to an original position of the drive part, and the bobbin includes a damper protruding from an inner peripheral surface of the through hole and interposed between the lower case and the drive part.

The lower case may include a cylindrical body surrounding the outer surface of the bobbin, a lower surface extending inward from a lower end of the body and surrounding the lower side of the bobbin in a ring shape, and a cylindrical inner surface extending upward from an inner end of the ring-shaped lower surface and inserted into the through hole, and the damper may be provided between the upper end of the inner surface and the drive part.

The drive part may include a large diameter part inserted into the through hole and a small diameter part provided with a diameter smaller than a diameter of the large diameter part, the small diameter part may be inserted into the inner surface, and the damper may be provided to contact a stepped part formed by a difference in diameter between the large diameter part and the small diameter part.

The solenoid actuator may include a drive rod moved by the drive part.

The drive rod may pass through the drive part and be coupled thereto.

A first bush may be provided between the drive rod and the inner surface, and the first bush may be provided in an opening formed inside the inner surface.

A second bush may be provided between the drive rod and the core.

The lower case may have the body, the lower surface, and the inner surface integrally formed.

An upper end of the drive part may be provided with a first inclined portion formed to be at least partially inclined, and a lower end of the core may be provided with a second inclined portion formed to be at least partially inclined at an angle corresponding to the first inclined portion and provided to contact the first inclined portion.

In accordance with yet another aspect of the present disclosure, a brake system includes a power transmission unit configured to transmit a rotational driving force of a motor to a pressing unit for pressing brake pads provided on both sides of a disc and a ratchet unit configured to prevent reverse operation of the power transmission unit, in which the ratchet unit includes a pawl provided to engage with a ratchet gear rotating with rotation of the motor and a solenoid actuator configured to rotate the pawl, the solenoid actuator includes a bobbin having a through hole formed on an inner surface thereof and including a winding part around which a coil is wound along an outer surface thereof, a lower case coupled to a lower side of the bobbin and surrounding the outer surface of the bobbin, a drive part inserted into the through hole to be drivable up and down, a core fixedly installed above the drive part, a return spring provided between the drive part and the core and configured to elastically support the drive part to an original position of the drive part, and a damper provided on an inner peripheral surface of the through hole and interposed between the lower case and the drive part, the lower case includes a cylindrical body surrounding the outer surface of the bobbin, a lower surface extending inward from a lower end of the body and surrounding the lower side of the bobbin in a ring shape, and a cylindrical inner surface extending upward from an inner end of the ring-shaped lower surface and inserted into the through hole, and the damper is provided between the upper end of the inner surface and the drive part.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a side view for illustrating a ratchet unit of a brake system in accordance with an embodiment of the present disclosure;

FIGS. 2 to 4 are cross-sectional views for illustrating a solenoid actuator in accordance with an embodiment of the present disclosure;

FIG. 5 is an enlarged cross-sectional view for illustrating a drive part and a core of a solenoid actuator in accordance with an embodiment of the present disclosure;

FIG. 6 is a cross-sectional view for illustrating a solenoid actuator in a state in which a drive part is driven upward in accordance with an embodiment of the present disclosure; and

FIG. 7 is a cross-sectional view illustrating a solenoid actuator in accordance with another embodiment of the present disclosure.

### DETAILED DESCRIPTION

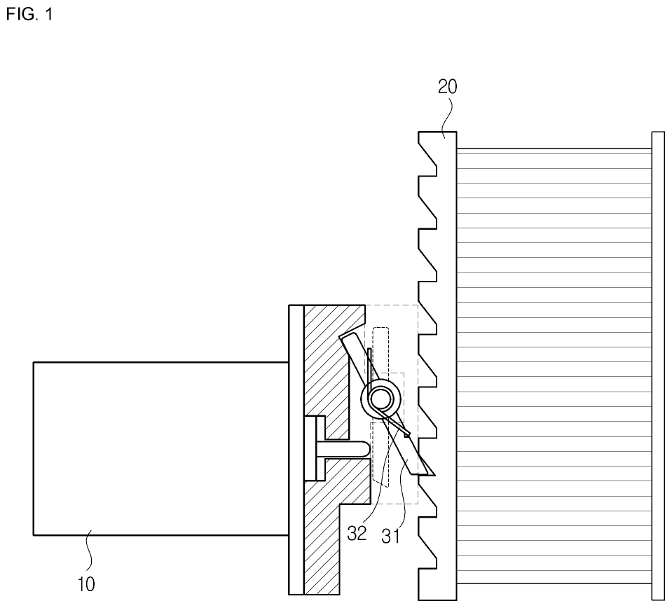

FIG. 1 is a side view illustrating a ratchet unit of a brake system in accordance with an embodiment of the present disclosure.

The brake system in accordance with the present embodiment may be, for example, but not limited to, a disc brake system. In the disc brake system, brake pads may be provided on both sides of a disc, and the disc brake system may include a caliper housing, a carrier, a motor for providing a driving force, a pressing unit for pressing the brake pads, a power transmission unit for transmitting the rotational driving force of the motor to the pressing unit, and the ratchet unit for preventing reverse movement or operation of the power transmission unit.

The caliper housing is an external frame of the brake system. The caliper housing is generally made of metal and serves to protect and support the brake pad and the pressing unit. The caliper housing is positioned around the disc in the disc brake and keeps the brake pads close to the disc.

The disc rotates with a vehicle's wheel and has brake pads on both sides.

The carrier is a component positioned inside the caliper housing and provides a mechanism configured to support and move the brake pads. The carrier controls the movement of the brake pads toward and away from the disc or in and out of contact with the disc and transmits a compressive force of the pads to the disc.

The pressing unit is a device configured to press the brake pads toward the disc. In general, the pressing unit operates when a brake pedal is pressed and generates pressure by utilizing hydraulic or electromechanical principles or mechanism. The pressure generated in this way is transmitted to a piston or cylinder within the caliper housing and presses the brake pads to the disc.

The configuration described above is a general configuration of the disc brake system and is a known technique that can be easily performed by a person skilled in the art, so detailed description thereof will be omitted. And, the configuration is described as an example for illustration purposes only and therefore the present disclosure is not limited thereto.

The motor may be configured to provide a rotational driving force. The motor may be positioned behind or coupled to the caliper housing and on the side of the power transmission unit and provide the rotational driving force to the power transmission unit.

The power transmission unit transmits the rotational driving force of the motor to the pressing unit. The power transmission unit may include, for example, but not limited to, one or a plurality of gears, a belt mechanism comprising a belt and pulleys, a nut-screw mechanism, and/or a ball nut-screw mechanism.

That is, the brake system of the present embodiment performs braking by transmitting the driving force of the motor to the pressing unit through the power transmission unit to press the brake pads toward the rotor. An electronic control unit (ECU) for controlling the motor may rotate the motor in a direction for pressing the brake pads, or rotate the motor in a reverse direction for releasing the pressure applied to the brake pads.

The ratchet unit may be configured to limit or prevent movement in one direction, for example, a reverse operation or movement of the power transmission unit. Unlike the electric parking brake in the related art, the electromechanical brake system according to an exemplary embodiment of the present disclosure may electrically implement both the service brake and the parking brake and thus may require a short time for operating the brake. Therefore, the electromechanical brake system reduces the operating time by utilizing ball screw spindles instead of existing lead screw spindles. However, in the ball nut-screw mechanism, reverse gear rotation may occur. The ratchet unit is provided with the power transmission unit to limit or prevent the reverse gear rotation in a certain condition.

Referring to FIG. 1, a ratchet unit according to an exemplary embodiment of the present disclosure may include a ratchet gear 20 configured to rotate in association with rotation of the motor, a pawl 31 configured to be engageable with the ratchet gear 20, a solenoid actuator 10 configured to rotate or pivot the pawl 31, and a spring 32 configured to provide a restoring force to the pawl 31. The spring 32 may be, for example, but not limited to, a pawl spring.

The ratchet gear 20 rotates by the rotation force of the motor. The ratch gear 20 may be directly coupled to the motor or indirectly or operably connected with the motor through one or more gears and/or a belt mechanism. The ratchet gear 20 may be a component of the power transmission unit, or may be provided to be connected to the power transmission unit to rotate in response to the operation of the power transmission unit.

The ratchet gear 20 is rotated by the motor and may be provided in a shape of a ratchet wheel. The ratchet wheel has teeth angled in one direction around the wheel, allowing rotation in a specific one direction through a stopper such as the pawl 31, but limiting or restricting rotation in an opposite direction to the specific one direction.

The solenoid actuator 10 moves, rotates, or pivots the pawl 31. The solenoid actuator 10 may include a bobbin 100 around which a coil is wound, a drive part 410 inserted into a through hole of the bobbin 100 to be driven, and a drive rod 420 configured to be movable by the drive part 410. The drive rod 420 may protrude outside a housing of the solenoid actuator 10 and be configured to press the pawl 31 to the ratchet gear 20 so that the pawl 31 is engaged with one of the teeth of the ratchet gear 20.

The pawl 31 is rotatably connected to a pawl support part or shaft such that when the solenoid actuator presses the pawl 31, one end of the pawl 31 engages with the teeth of the ratchet gear 20.

The spring 32 may provide an elastic force in a direction of moving the pawl 31 away from the ratchet gear 20.

The brake system according to an exemplary embodiment of the present disclosure may include the ratchet unit such that the pawl 31 of the ratchet unit can be coupled to or engaged with the ratchet gear 20 by the solenoid actuator 10, thereby preventing reverse movement or operation of the brake.

Hereinafter, the solenoid actuator 10 according to some exemplary embodiments of the present disclosure will be described in more detail.

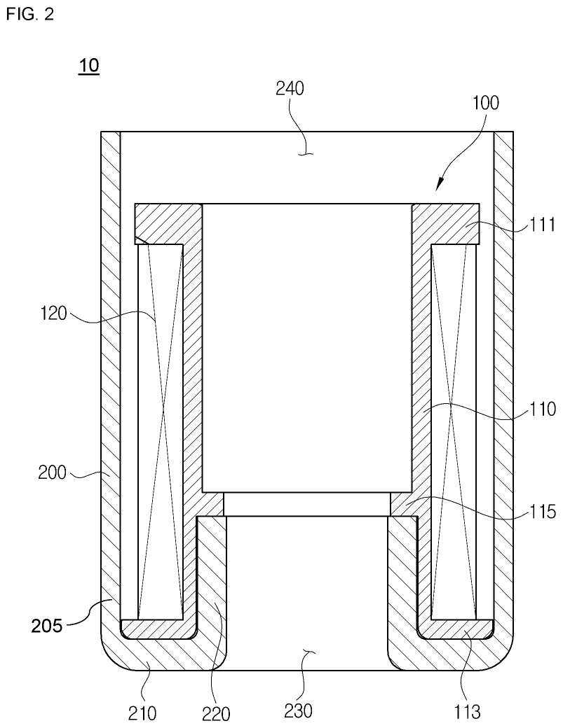

FIGS. 2 to 4 are cross-sectional views for illustrating a solenoid actuator in accordance with an exemplary embodiment of the present disclosure.

Referring to FIGS. 2 to 4, a configuration and manufacturing sequence of the solenoid actuator 10 according to some exemplary embodiments of the present disclosure will be described in detail.

Referring to FIGS. 2 to 4, the solenoid actuator 10 according to an embodiment of the present disclosure may include a bobbin 10, a lower case 200, a drive part 410, a core 300, a drive rod 420, and a return spring 500. The bobbin 100 may have a through hole formed on an inner surface thereof. The bobbin 100 may include a winding part 110 around which a coil 120 is wound along an outer surface of the bobbin 100. The lower case 200 may be coupled to a lower side of the bobbin 100 and surround the outer surface of the bobbin 100. The drive part 410 may be inserted into the through hole of the bobbin 100 to be drivable up and down. The core 300 may be fixedly installed above the drive part 410. The drive rod 420 may protrude above or out of the core 300 through the core 300 and can be moved by the drive part 410. The return spring 500 may be provided between the drive part 410 and the core 300 and may be configured to provide a restoring force according to driving of the drive part 410.

Referring to FIG. 2, the bobbin 100 has the winding part 110 around which the coil 120 is wound, and the through hole is formed on the inner surface of the bobbin 100. The coil 120 configured to generate a magnetic field when electric power is applied or supplied to the coil 120.

The bobbin 100 may further include an upper frame 111 provided above the winding part 110 to limit an upper winding range of the coil 120 or the movement of the coil 120 in an upward direction and a lower frame 113 provided below the winding part 110 to limit a lower winding range of the coil 120 or the movement of the coil 120 in a downward direction.

The bobbin 100 is provided with the through hole into which the drive part 410 and the core 300 are allowed to be inserted such that the drive part 410 and the core 300 can be movable in the through hole of the bobbin 100.

The lower case 200 may basically have a cylindrical body 205 surrounding the outer surface of the bobbin 100. The bobbin 100 may be inserted into the inside of the cylindrical body 205 of the lower case 200.

In addition, the lower case 200 may include a lower part or surface (or an extension part) 210 and a cylindrical inner part or surface 220. The lower part or surface or extension part 210 may extend inward from a lower end of the body 205 of the lower case 200 (e.g. a direction toward an axis of the solenoid actuator 10) and surround the lower side portion of the bobbin 100, and may have a ring shape. The cylindrical inner part or surface 220 may extend upward from an inner end of the ring-shaped lower surface 210 and be at least partially inserted into the through hole of the bobbin 100.

That is, the lower case 200 may accommodate the bobbin 100 therein with a shape that surrounds outer, lower, and inner side portions of the bobbin 100 except for an upper side portion of the bobbin 100. In this exemplary embodiment, the inner surface or part 220 of the lower case 200 may have an outer diameter corresponding to an inner diameter of the through hole of the bobbin 100. Thereby, when the bobbin 100 is assembled to the inside of the lower case 200, as illustrated in FIG. 2, the through hole of the bobbin 100 and the inner surface or part 220 of the lower case 200 come into contact with each other, so that the bobbin 100 may be fixed at a certain position inside the lower case 200.

The lower case 200 may have the body 205, the lower part or surface or extension part 210, and the inner part or surface 220 which are integrally formed. For instance, the lower case 200 may have a shape in which the upper side of the lower case 200 is open such that the lower case 200 can be formed as one piece through a process such as press molding.

As described above, the lower case 200 includes the cylindrical body 205, the ring-shaped lower part or surface or extension part 210 extending inward from the lower end of the body, and the inner part or surface 220 extending upward from the inner end of the lower surface. A first opening 230 that opens downward may be formed inside the cylindrical inner part or surface 220 of the lower case 200, and a second opening 240 that opens upward may be formed inside the cylindrical body 205 of the lower case 200.

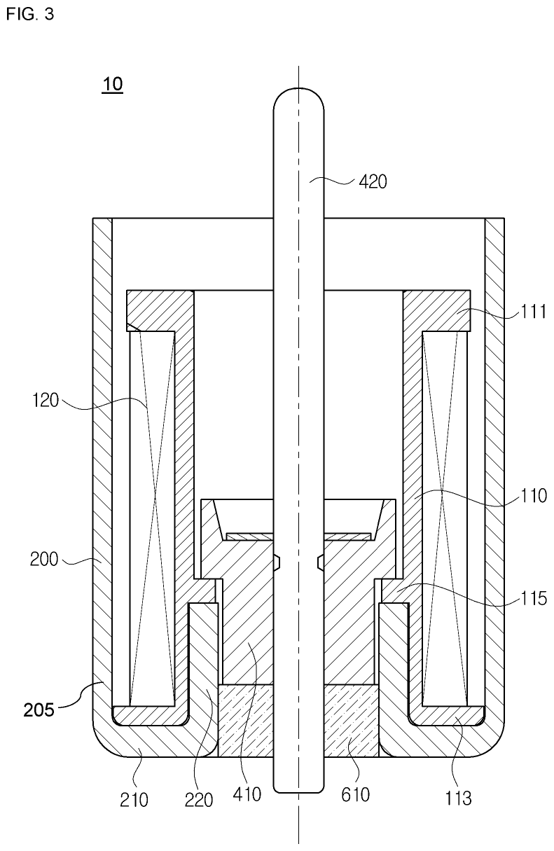

Referring to FIG. 3, the drive part 410 is inserted into the through hole of the bobbin 100 to be drivable up and down. The drive part 410 is configured to be driven up and down by a magnetic field generated by the coil 120, wound around the bobbin 100, and induced through the core 300. Preferably, the drive part 410 may be made of a magnetic material, although not required.

The drive part 410 may be driven up and down inside the through hole of the bobbin 100. A drivable or movable range of the drive part 410 may be limited by the core 300 and the lower case 200. For example, the upmost drivable or movable range of the drive part 140 is limited by the core 300 and the downmost drivable or movable range of the drive part 140 is limited by the lower case 200.

The bobbin 100 may be provided with a damper 115 that protrudes from an inner peripheral surface of the through hole of the bobbin 100 to prevent the lower case 200 and the drive part 410 from directly contacting each other.

As illustrated in FIGS. 2 and 3, the damper 115 has a shape that inwardly protrudes from the inner peripheral surface of the through hole of the bobbin 100. In the present embodiment, the damper 115 may protrude in a ring shape along a circumferential direction from the inner peripheral surface of the through hole of the bobbin 100. Alternatively, the damper 115 may be formed as a plurality of protrusions protruding from the inner peripheral surface of the through hole of the bobbin 110, spaced apart from each other and aligned along the circumferential direction.

The damper 115 may be interposed between the drive part 410 and the lower case 200 by protruding from the inner peripheral surface of the through hole of the bobbin 100, thereby preventing the drive part 410 from directly contacting the lower case 200.

The drive part 410 is driven within the drivable or movable range according to the magnetic field generated by the coil 120. When the drive part 410 directly contacts the lower case 200 while being driven up and down, noise may be generated due to impact of the direct contact and damage may be inflicted on the lower case 200 or the drive part 410.

However, according to an embodiment of the present disclosure, the damper 115 of the bobbin 110 can prevent the drive part 410 from directly contacting the lower case 200, thereby preventing noise and damage due to the impact.

In an exemplary embodiment of the present disclosure, the damper 115 may be formed integrally with the bobbin 100. For example, the damper 115 can be formed on the inner surface of the bobbin 100 by molding. By forming the damper 115 integrally with the bobbin 100, the assemblability and productivity of the solenoid actuator 10 may be improved, and manufacturing costs may be reduced by simplifying the design.

Alternatively, the damper 115 may be manufactured as a separate piece element and inserted into the inside of the bobbin 100 to be positioned between the drive part 410 and the lower case 200.

In an exemplary embodiment of the present disclosure, the damper 115 may contact the upper end of the inner surface 220 of the lower case 200, thereby preventing the drive part 410 from directly contacting the inner surface 220 of the lower case 200. The inner part or surface 220 of the lower case 200 is inserted into the through hole of the bobbin 100. In this exemplary embodiment, the damper 115 may be positioned on the upper end of the inner part or surface 220 of the lower case 200, thereby preventing the drive part 410 from contacting the inner part or surface 220 of the lower case 200.

If no damper is provided in the bobbin 100, the drive part 410 inside the through hole of the bobbin 100 may contact the inner part or surface 220 of the lower case 200 while the drive part 410 is moving downwardly. Accordingly, when the drive part 410 is driven to move downward, noise may be generated due to the contact between the drive part 410 and the inner part or surface 220 of the lower case 200. The damper 115 may be interposed and positioned between the lower end of the drive part 410 and the upper end of the inner part or surface 220 of the lower case 200 by protruding from the inner peripheral surface of the through hole of the bobbin 100, thereby preventing direct contact between the drive part 410 and the inner part or surface 220 of the lower case 200 so that noise can be reduced and damage due to contact shock can be prevented.

The drive rod 420 may pass through the drive part 410 and be fixedly coupled to the drive part 410. The drive rod 420 may be moved by the drive part 410 and apply a force to an external device or another part, for example, but not limited to, the pawl 31, through an end of the drive rod 420 protruding outward from the solenoid actuator 10. Preferably, one end of the drive rod 420 may protrude above the housing of the solenoid actuator 10, and the protruded end of the drive rod 420 may press an external device. For example, in the ratchet unit illustrated in FIG. 1, the end of the drive rod 420 may rotate or pivot the pawl 31 by pressing the pawl 31 so that the pawl 31 is fastened to or engaged with the ratchet gear 20.

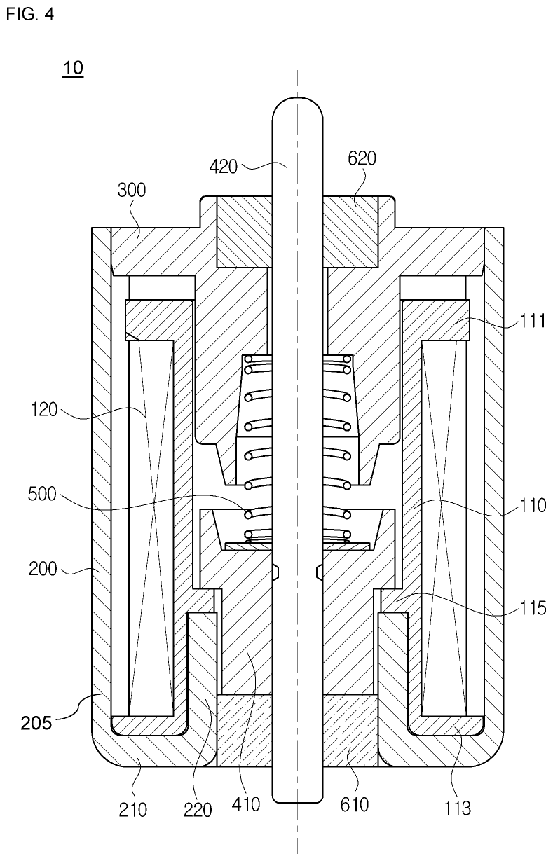

Referring to FIG. 4, the core 300 is fixedly installed above the drive part 410. For example, the core 300 can be fixed to the lower case 200 or any part of the housing of the solenoid actuator 10. In the embodiment shown in FIG. 4, the core 300 may be fixedly installed to close or cover the second opening 240 formed at the upper side of the lower case 200.

The core 300 induces a magnetic field generated in the coil 120. The core 300 is made of, for example, but not limited to, a magnetic material and is fixedly installed above the drive part 410. At least a portion of the core 300 may be inserted into the through hole of the bobbin 100.

The core 300 induces the magnetic field generated in the coil 120 and causes the drive part 410 to be driven toward the core 300, for example, upward in FIG. 4, by the magnetic field generated when electric power is applied to the coil 120.

The return spring 500 may be provided between the core 300 and the drive part 410. The return spring 500 is provided to elastically support the drive part 410 to an original position of the drive part 410 by providing a reaction force according to driving of the drive part 410. The return spring 500 may be configured to apply an elastic force to the drive part 410 in a direction of being away from the core 300 such that the return spring 500 can return the drive part 410 to its original position. For instance, the return spring 500 may be provided as a coil spring, and as the drive part 410 is driven upward by the magnetic field generated by the coil 120, the return spring 500 may compressed, and when the magnetic field is not generated by the coil 120, the compressed return spring 500 may provide the reaction force to the drive part 410 so that the drive part 410 can be driven downward.

The drive rod 420 may pass through the core 300 and protrude above the core 300. The drive rod 420 may be movably positioned in the core 300. The drive rod 420 passes through the core 300 and can move up and down with respect to the core 300 by being driven by the drive part 410. Accordingly, the end of the drive rod 420 protruding above the core 300 may provide or transmit a driving force to an external device by moving up and down.

Meanwhile, the drive rod 420 may pass through the drive part 410 and protrude below the drive part 410. In this exemplary embodiment, a first bush 610 may be provided between the drive rod 420 and the inner part or surface 220 and may be positioned below the lower side of the drive part 410. The drive rod 420 may be movably coupled to the first bush 610 so that the drive rod 420 can be moved inside the first bush 610. The first bush 610 may be configured to guide the movement of the drive rod 420 configured to be movable according to the driving of the drive part 410 and reduce friction.

In addition, a second bush 620 may be provided between the drive rod 420 and the core 300. The drive rod 420 may be movably positioned in the second bush 620. The drive rod 420 can move up and down with respect to the second bush 620. The second bush 620 may be configured to guide the movement of the drive rod 420 and reduce friction.

As illustrated in FIG. 4, the first bush 610 may be provided on the lower side portion of the drive part 410, and the second bush 620 may be provided on the upper side portion of the drive part 410, thereby guiding vertical movement of the drive rod 420 caused by the driving of the drive part 410, reducing friction, and preventing the drive rod 420 from deviating from an axial direction.

Meanwhile, the first bush 610 is provided between the drive rod 420 and the inner part or surface 220 of the lower case 200 and provided in the first opening 230 formed inside the cylindrical inner part or surface 220 of the lower case 200. Since the first bush 610 is provided in the first opening 230 of the lower case 200, wear dust generated by friction or the like during the operation of the drive rod 420 may be discharged to the outside of the housing of the solenoid actuator 10 through the first opening 230 of the lower case 200.

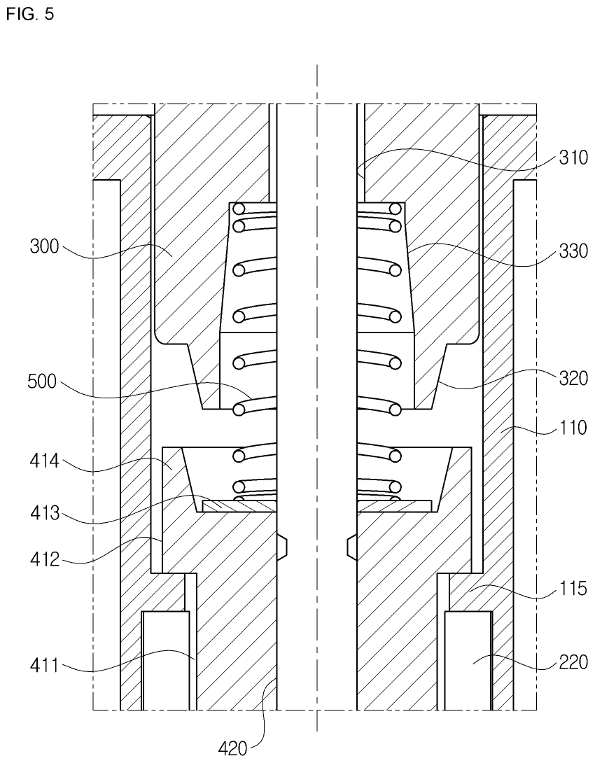

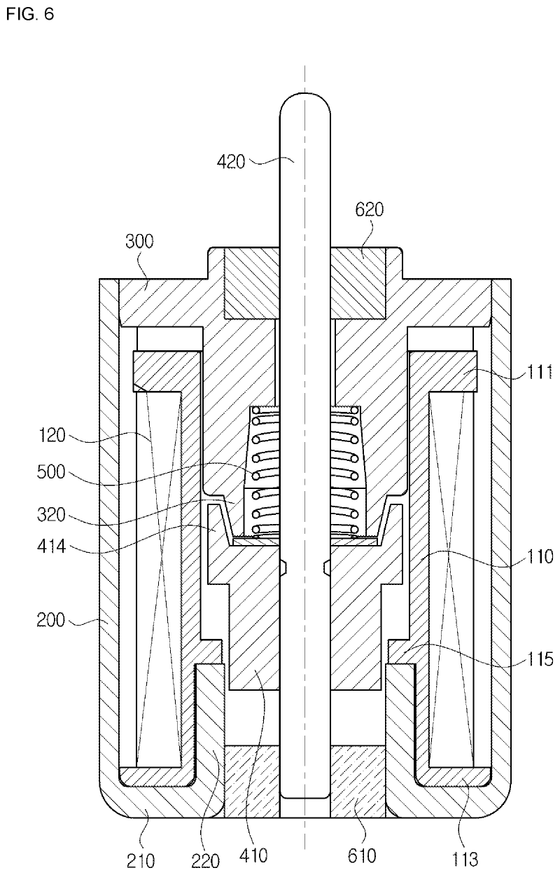

FIG. 5 is an enlarged cross-sectional view illustrating a drive part and a core of a solenoid actuator in accordance with an embodiment of the present disclosure, and FIG. 6 is a cross-sectional view of a solenoid actuator in a state in which a drive part is driven upward in accordance with an embodiment of the present disclosure.

Referring to FIG. 5, the return spring 500 may be provided to be inserted or disposed between a first spring seating part 413 on the upper side of the drive part 410 and a second spring seating part 330 of the core 300. For example, the second spring seating part 330 of the core 300 may be formed as a concave groove on the lower side of the core 300. Even when the return spring 500 is compressed by being inserted into the second spring seating part 330 formed as the concave groove, the return spring 500 may be prevented from deviating, and the reaction force caused by the compression of the return spring 500 may be appropriately controlled.

In addition, the return spring 500 may be provided as a coil spring surrounding at least a portion of the drive rod 420.

Meanwhile, the first spring seating part 413 may be provided with a damping member or damper configured to absorb shock caused by upward driving of the drive part 410. The damping member or damper of the first spring seating part 413 may be provided between the drive part 410 and the core 300 so that direct contact between the drive part 410 and the core 300 can be prevented when the drive part 410 moves upward, thereby reducing noise and preventing damage due to driving shock.

Referring to FIG. 5, the drive part 410 according to an exemplary embodiment of the present disclosure may have a large diameter part 412 inserted into the through hole of the bobbin 100 and a small diameter part 411 having a diameter smaller than the large diameter part 412.

The large diameter part 412 is inserted into the through hole of the bobbin 100 and has an outer diameter smaller than the diameter of the through hole of the bobbin 100. The small diameter part 411 has an outer diameter smaller than the large diameter part 412 and is inserted into the inner part or surface 220 of the lower case 200 inserted into the through hole of the bobbin 100.

The drive part 410 has a stepped portion formed by a difference in diameters between the large diameter part 412 and the small diameter part 411. By having the stepped portion in the drive part 410, the small diameter part 411 can be inserted into the inner part or surface 220 of the lower case 200, but the large diameter part 412 cannot be inserted into the inner part or surface 220 of the lower case 200. Accordingly, the stepped portion of the drive part 410 may contact the inner surface 220 and can limit the downward movable range of the drive part 410.

The damper 115 according to an embodiment of the present disclosure may contact the stepped part of the drive part 410 formed by the difference in diameters between the large diameter part 412 and the small diameter part 411. The damper 115 may prevent the drive part 410 from directly contacting the inner part or surface 220 of the lower case 200 by contacting the stepped portion of the drive part 410. The damper 115 may be in contact with the upper end of the inner part or surface 220 and may be configured to be contactable with the stepped portion of the drive part 410 when the drive part 410 is driven downward, so that the stepped portion of the drive part 410 can be prevented from contacting the inner part or surface 220 of the lower case 200.

On the other hand, in an example in which surfaces of the core 300 and the drive part 410 facing each other are formed to be flat, as the drive part 410 approaches the core 300, the magnetic force between the drive part 410 and the core 300 may increase rapidly, causing driving shock when the drive part 410 moves upward.

Therefore, in an exemplary embodiment of the present disclosure, the upper end of the drive part 410 may be provided with a first inclined portion 414 that is at least partially inclined at a certain angle greater than 0°, the lower end of the core 300 may be provided with a second inclined portion 320 that is inclined at an angle substantially corresponding to the first inclined portion 414, and the second inclined portion 320 may be provided to face or contact the first inclined portion 414 by being inserted into the first inclined portion 414 when the drive part 410 is driven upward.

The upper end of the drive part 410 facing the core 300 may be provided with the first inclined portion 414 inclined at a certain angle as illustrated in FIG. 5, and the first inclined portion 414 of the drive part 410 may be formed at the large diameter part 412 on the upper side of the drive part 410.

The lower end of the core 300 facing the drive part 410 is provided with the second inclined portion 320 inclined at a certain angle as illustrated in FIG. 5. The second inclined portion 320 of the core 300 may have a shape substantially corresponding to the first inclined portion 414 of the drive part 410 and contact or face the first inclined portion 414 of the drive part 410 by being inserted into the first inclined portion 414 when the drive part 410 is driven upward.

As illustrated in FIG. 6, when the drive part 410 is moving closer to the core 300, the second inclined portion 320 is inserted into the first inclined portion 414, and the lower end of the second inclined portion 320 and the upper end of the first inclined portion 414 partially overlap. Accordingly, the magnetic force received by the drive part 410 due to the magnetic field induced by the core 300 may not rapidly increase, and the drive part 410 may be driven upward by a constant magnetic force.

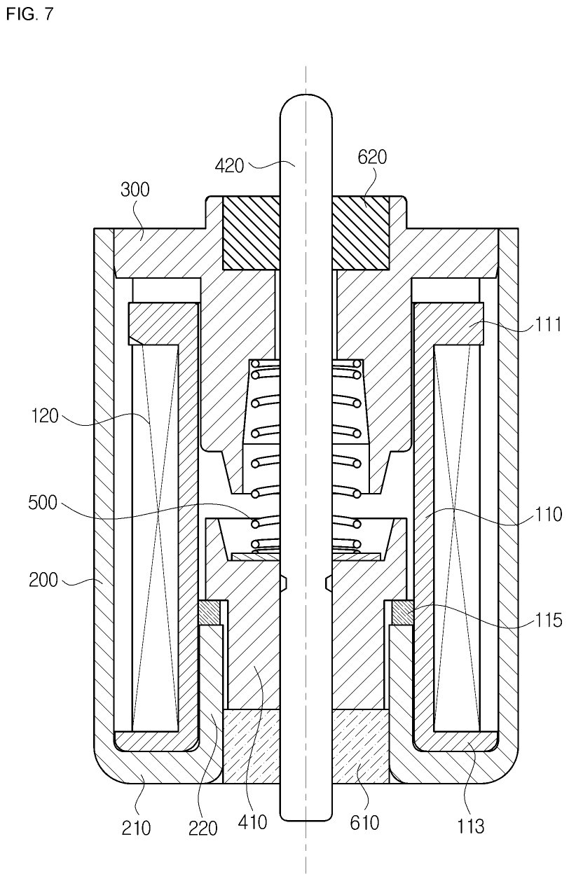

FIG. 7 is a cross-sectional view illustrating a solenoid actuator in accordance with another embodiment of the present disclosure.

Referring to FIG. 7, a solenoid actuator according to another embodiment of the present disclosure may include a bobbin 100, a lower case 200, a drive part 410, a core 300, a drive rod 420, and a return spring 500. The bobbin 100 may have a through hole formed on an inner surface of the bobbin 100 and may include a winding part 110 around which a coil 120 is wound along an outer surface of the bobbin 100. The lower case 200 may be coupled to a lower side portion of the bobbin 100 and surround the outer surface of the bobbin 100. The drive part 410 may be inserted into the through hole of the bobbin 100 to be drivable up and down. The core 300 may be fixedly installed above the drive part 410. The drive rod 420 may protrude above or out of the core 300 through the core 300 and may be configured to be movable by the drive part 410. The return spring 500 may be provided between the drive part 410 and the core 300 and provide a restoring force according to the driving of the drive part 410.

The lower case 200, the drive part 410, the core 300, the drive rod 420, and the return spring 500 according to another embodiment illustrated in FIG. 7 may have the same or similar configurations as or to the embodiment shown in FIGS. 2 to 6, and description thereof will be omitted.

Referring to FIG. 7, a solenoid actuator 10 in accordance with another embodiment of the present disclosure may include a damper 115 provided on an inner peripheral surface of the through hole of the bobbin 100 in order to prevent direct contact between the lower case 200 and the drive part 410. Unlike the embodiment of FIGS. 2 to 6, the solenoid actuator 10 in accordance with another embodiment of FIG. 7 may have the damper 115 and the bobbin 100 provided or formed separately.

The damper 115 may be interposed or positioned between the drive part 410 and the lower case 200 by being provided on the inner peripheral surface of the through hole, thereby preventing the drive part 410 from directly contacting the lower case 200.

The drive part 410 is driven within a drivable or movable range according to the magnetic field generated or formed by the coil 120. When the drive part 410 directly contacts the lower case 200 while being driven up and down, noise may be generated due to impact and damage may be inflicted on the lower case 200 or the drive part 410.

The damper 115 can prevent the drive part 410 from directly contacting the lower case 200, thereby preventing noise and damage due to impact.

In another embodiment of FIG. 7, the damper 115 may be contactable with the upper end of the inner part or surface 220 of the lower case 200, thereby preventing the drive part 410 from directly contacting the inner part or surface 220 of the lower case 200. The inner part or surface 220 of the lower case 200 is inserted into the through hole of the bobbin 100. In this exemplary embodiment, the damper 115 may be positioned above or on the upper end of the inner surface 220, thereby preventing the drive part 410 from contacting the inner part or surface 220 of the lower case 200.

If no damper is provided in the bobbin 100, the drive part 410 inside the through hole of the bobbin 100 may contact the inner part or surface 220 of the lower case 200 while the drive part 410 is moving downwardly. Accordingly, when the drive part 410 is driven to move downward, noise may be generated due to contact between the drive part 410 and the inner surface 220. The damper 115 may be interposed and positioned between the lower end of the drive part 410 and the upper end of the inner part or surface 220 of the lower case 200 by protruding from the inner peripheral surface of the through hole of the bobbin 100, thereby preventing direct contact between the drive part 410 and the inner surface 220 so that noise can be reduced and damage due to contact shock can be prevented.

Therefore, a solenoid actuator and a brake system including the same in accordance with some embodiments of the present disclosure can reduce operating noise of the solenoid actuator.

A solenoid actuator and a brake system including the same in accordance with certain embodiments of the present disclosure can maintain a constant magnetic force during the operation of the solenoid actuator.

A solenoid actuator and a brake system including the same in accordance with some embodiments of the present disclosure can improve assemblability and productivity by simplifying a product structure and shape of the solenoid actuator.

A solenoid actuator and a brake system including the same in accordance with certain embodiments of the present disclosure can promote design simplification and manufacturing cost reduction.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A solenoid actuator comprising:
a bobbin having a through hole formed inside the bobbin, wherein a coil is wound around the bobbin;
a case surrounding an outer surface of the bobbin;
a drive part movably disposed in the through hole of the bobbin to be drivable;
a core fixedly disposed above the drive part; and
a return spring disposed between the drive part and the core and configured to apply an elastic force to the drive part in a direction of being away from the core,
wherein the bobbin has a damper positioned between the case and the drive part.

2. The solenoid actuator according to claim 1, wherein:
the case includes a body surrounding an outer side surface of the bobbin, an extension part extending inward from the body in a radial direction and surrounding an end of the bobbin, and a inner part extending from the extension part in an axial direction such that the inner part of the case is inserted into the through hole of the bobbin, and
the damper is provided between an end of the inner part of the case inserted in the through hole of the bobbin and the drive part.

3. The solenoid actuator according to claim 2, wherein:
the drive part includes a large diameter part inserted in the through hole of the bobbin and a small diameter part having a diameter smaller than a diameter of the large diameter part,
the small diameter part is inserted in the inner part of the case inserted in the through hole of the bobbin, and
the damper is configured to be contactable with a stepped portion of the drive part formed by the large diameter part and the small diameter part.

4. The solenoid actuator according to claim 2, further comprising a drive rod configured to be movable by the drive part.

5. The solenoid actuator according to claim 2, further comprising a drive rod fixedly coupled to the drive part.

6. The solenoid actuator according to claim 5, further comprising a first bush positioned between the drive rod and the inner part of the case inserted in the through hole of the bobbin,
wherein the first bush is disposed in a first opening formed inside the inner part of the case inserted in the through hole of the bobbin.

7. The solenoid actuator according to claim 5, further comprising a second bush positioned between the drive rod and the core.

8. The solenoid actuator according to claim 2, wherein the body, the extension part, and the inner part of the case are integrally formed as a single piece.

9. The solenoid actuator according to claim 1, wherein:
an end of the drive part has a first inclined portion and an end of the core has a second inclined portion inclined at an angle corresponding to the first inclined portion of the drive part such that one of the first inclined portion of the drive part and the second inclined portion of the core is insertable into another of the first inclined portion of the drive part and the second inclined portion of the core.

10. The solenoid actuator according to claim 1, wherein the damper is formed by a protruded part of the bobbin inwardly protruding from an inner surface of the through hole of the bobbin to be between the case and the drive part.

11. The solenoid actuator according to claim 1, wherein the damper is provided on an inner surface of the through hole of the bobbin to be disposed between the case and the drive part.

12. A brake system comprising a ratchet unit configured to prevent reverse brake operation,
wherein the ratchet unit includes:
a pawl configured to engageable with a ratchet gear configured to be rotatable according to a force generated by a motor; and
a solenoid actuator configured to move the pawl,
the solenoid actuator includes:
a bobbin having a through hole formed inside the bobbin, wherein a coil is wound around the bobbin;
a case surrounding an outer surface of the bobbin;
a drive part movably disposed in the through hole of the bobbin to be drivable;
a core fixedly disposed above the drive part; and
a return spring disposed between the drive part and the core and configured to apply an elastic force to the drive part in a direction of being away from the core, and
the bobbin has a damper positioned between the case and the drive part.

13. The brake system according to claim 12, wherein:
the case includes a body surrounding an outer side surface of the bobbin, an extension part extending inward from the body in a radial direction and surrounding an end of the bobbin, and an inner part extending from the extension part in an axial direction such that the inner part of the case is inserted into the through hole of the bobbin, and
the damper is provided between an end of the inner part of the case inserted in the through hole of the bobbin and the drive part.

14. The brake system according to claim 13, wherein:
the drive part includes a large diameter part inserted in the through hole of the bobbin and a small diameter part having a diameter smaller than a diameter of the large diameter part,
the small diameter part is inserted in the inner part of the case inserted in the through hole of the bobbin, and
the damper is configured to be contactable with a stepped portion of the drive part formed by the large diameter part and the small diameter part.

15. The brake system according to claim 13, further comprising a drive rod configured to be movable by the drive part.

16. The brake system according to claim 13, further comprising a drive rod fixedly coupled to the drive part.

17. The brake system according to claim 16, further comprising a first bush positioned between the drive rod and the inner part of the case inserted in the through hole of the bobbin, and
wherein the first bush is disposed in an opening formed inside the inner part of the case inserted in the through hole of the bobbin.

18. The brake system according to claim 16, further comprising a second bush positioned between the drive rod and the core.

19. The brake system according to claim 12, wherein:
an end of the drive part has a first inclined portion and an end of the core has a second inclined portion inclined at an angle corresponding to the first inclined portion of the drive part such that one of the first inclined portion of the drive part and the second inclined portion of the core is insertable into another of the first inclined portion of the drive part and the second inclined portion of the core.

20. The brake system according to claim 12, wherein the damper is formed by a protruded part of the bobbin inwardly protruding from an inner surface of the through hole of the bobbin between the case and the drive part.
